(19) United States
(12) Patent Application Publication
(10) Pub. No.: US 2022/0173390 A1
(43) Pub. Date: Jun. 2, 2022

(54) CATHODE ACTIVE MATERIAL FOR LITHIUM SECONDARY BATTERY AND METHOD OF MANUFACTURING THE SAME

(71) Applicant: SK INNOVATION CO., LTD., Seoul (KR)

(72) Inventors: Yeong Bin YOO, Daejeon (KR); Hee Jun KWEON, Daejeon (KR); Tae Kyoung LEE, Daejeon (KR); Ji Hoon CHOI, Daejeon (KR); Kook Hyun HAN, Daejeon (KR)

(21) Appl. No.: 17/540,072

(22) Filed: Dec. 1, 2021

(30) Foreign Application Priority Data
Dec. 2, 2020 (KR) 10-2020-0166935

(51) Int. Cl. H01M 4/525; H01M 4/36; H01M 4/505; H01M 10/0525

(52) U.S. Cl. CPC H01M 4/525; H01M 10/0525; H01M 4/505; H01M 4/366

(57) ABSTRACT

The cathode active material according to exemplary embodiments includes lithium metal oxide particle including a layered crystal structure and a cubic crystal structure, wherein the lithium metal oxide particle contains 80 mol % or more of nickel based on a total number of moles of all elements except for lithium and oxygen, and the lithium metal oxide particle includes the cubic crystal structure only in a region having a thickness of less than 200 nm from a surface thereof when analyzing a crystal structure thereof by a high-resolution transmission electron microscopy.

### CROSS-REFERENCE TO RELATED APPLICATION AND CLAIM OF PRIORITY

This application claims priority to Korean Patent Application No. 10-2020-0166935 filed on Dec. 2, 2020 in the Korean Intellectual Property Office (KIPO), the entire disclosure of which is incorporated by reference herein.

### BACKGROUND OF THE INVENTION

### 1. Field of the Invention

The present invention relates to a cathode active material for a lithium secondary battery and a method of manufacturing the same, and more specifically, to a cathode active material which includes lithium metal oxide particles containing nickel and a method of manufacturing the same.

### 2. Description of the Related Art

A secondary battery is a battery that can be repeatedly charged and discharged, and is widely applied as a power source for portable electronic devices such as mobile phones, and notebook PCs with the development of information communication and display industries.

For example, secondary batteries include a lithium secondary battery, a nickel-cadmium battery, a nickel-hydrogen battery and the like. Among them, the lithium secondary battery has a high operating voltage and a high energy density per unit weight, and is advantageous in terms of a charging speed and light weight. In this regard, the lithium secondary battery has been actively developed as a power source.

For example, the lithium secondary battery may include: an electrode assembly including a cathode, an anode, and a separation membrane; and an electrolyte in which the electrode assembly is impregnated. In addition, the lithium secondary battery may further include an outer case in which the electrode assembly and the electrolyte are housed.

For example, the cathode of a lithium secondary battery may be prepared by coating a cathode current collector with a cathode slurry including a cathode active material, a binder, and if necessary, a conductive material, followed by drying and rolling the same.

For example, the cathode active material may include a material capable of reversibly intercalating and deintercalating lithium ions.

For example, the cathode active material may include a lithium metal oxide, and the lithium metal oxide may include a metal element such as nickel (Ni), cobalt (Co), manganese (Mn), aluminum (Al) and the like.

Meanwhile, in order to increase a capacity of the lithium secondary battery, research on a lithium metal oxide containing nickel in a high content (‘high-Ni-based lithium metal oxide’), in which a content of nickel element is 80 mol % or more based on a total number of moles of all elements except for lithium, has been conducted.

However, the high-Ni-based lithium metal oxide has a characteristic of including a significant amount of residual lithium (e.g., lithium impurities such as LiOH, Li₂CO₃, etc.) on the surface thereof by cation mixing of lithium ions with nickel ions.

For example, the residual lithium may cause gelation of the cathode slurry, swelling of the battery, etc., such that a manufacturing process of the high-Ni-based lithium metal oxide commonly involves a water washing process.

For example, Korean Patent Registration Publication No. 10-0821523 discloses a water washing process of washing the lithium metal oxide with water, followed by drying and performing heat treatment in order to remove residual lithium on the surface of NCA-based lithium metal oxide.

### SUMMARY OF THE INVENTION

It is an object of the present invention to provide a high-Ni-based cathode active material having structural stability, and a method of manufacturing the same.

Another object of the present invention is to provide a lithium secondary battery having improved life-span characteristics and high temperature stability.

To achieved the above objects, according to an aspect of the present invention, there is provided a cathode active material including: lithium metal oxide particle which includes a layered crystal structure and a cubic crystal structure, wherein the lithium metal oxide particle contains 80 mol % or more of nickel based on a total number of moles of all elements except for lithium and oxygen, and the lithium metal oxide particle includes the cubic crystal structure only in a region having a thickness of less than 200 nm from a surface thereof when analyzing a crystal structure thereof by a high-resolution transmission electron microscopy (HR-TEM).

In one embodiment, the lithium metal oxide particle may include the cubic crystal structure only in a region having a thickness of 25 nm from a surface thereof.

In one embodiment, the lithium metal oxide particle may have a specific surface area of 0.25 m²/g or less.

In one embodiment, the lithium metal oxide particle may have a specific surface area of 0.05 m²/g to 0.25 m²/g.

In one embodiment, a total amount of residual lithium present in the lithium metal oxide particle may be 6000 ppm or less.

In one embodiment, a total amount of residual lithium present in the lithium metal oxide particle may be 3000 ppm or less.

In one embodiment, the cathode active material may include a coating layer formed on at least a portion of the surface of the lithium metal oxide particle and including metal, metalloid or non-metal.

In one embodiment, the coating layer may include at least one of aluminum, zirconium, sulfur and boron.

In one embodiment, the lithium metal oxide particle may be represented by Formula 1.

LixNiaCobMcOy [Formula 1]

In Formula 1, M is at least one of Al, Zr, Ti, B, Mg, Mn, Ba, Si, Y, W and Sr, and x, y, a, b and c are a range of 0.9≤x≤1.2, 1.9≤y≤2.1, 0.8≤a≤1, 0≤c/(a+b)≤0.13 and 0≤c≤0.11.

In addition, according to another aspect of the present invention, there is provided a method of manufacturing a cathode active material, including: preparing lithium metal oxide particles; and treating the lithium metal oxide particles with steam or a steam-containing gas without washing with water.

In one embodiment, each of the lithium metal oxide particles may include a layered crystal structure, and may contain 80 mol % or more of nickel based on a total number of moles of all elements except for lithium and oxygen.

In one embodiment, the steam-containing gas may include at least one of oxygen gas, nitrogen gas and argon gas.

In one embodiment, the treating with steam or a steam-containing gas may be performed at 100° C. or higher, and the steam or the steam-containing gas contains hydroxyl radicals.

In one embodiment, the treating with steam or a steam-containing gas may include: increasing a material temperature of the lithium metal oxide particles; and spraying water on the lithium metal oxide particles with the increased material temperature.

In one embodiment, the lithium metal oxide particles with the increased material temperature may have a material temperature of 100 to 500° C.

In one embodiment, the treating with steam or a steam-containing gas may include: loading the lithium metal oxide particles into a reaction furnace having an internal temperature of 100° C. or higher; and spraying water on the lithium metal oxide particles.

In one embodiment, the treating with steam or a steam-containing gas may be performed while stirring the lithium metal oxide particles.

In one embodiment, the treating with steam or a steam-containing gas may include supplying an oxidant.

In one embodiment, the oxidant may include at least one of hydrogen peroxide (H₂O₂), potassium permanganate (KMnO₄), and sodium peroxide disulfate (Na₂S₂O₈)

In one embodiment, the treating with steam or a steam-containing gas may include supplying a coating source including metal, metalloid or non-metal.

In one embodiment, the coating source may include at least one of sodium aluminate (NaAlO₂), zirconium nitrate (Zr(NO₃)₄), sodium peroxide disulfate (Na₂S₂O₈) and boric acid (H₃BO₃).

In one embodiment, the method may further include coating at least a portion of the surface of the lithium metal oxide particles with metal, metalloid or non-metal after the treating with steam or a steam-containing gas.

Further, according to another aspect of the present invention, there is provided a lithium secondary battery including: the cathode which may include the cathode active material according to the above-described embodiments; and an anode disposed to face the cathode.

The method of manufacturing a cathode active material according to exemplary embodiments may further reduce an amount of residual lithium (i.e., lithium impurities) present in lithium metal oxide particles (e.g., high-Ni-based lithium metal oxide particles).

The method of manufacturing a cathode active material according to exemplary embodiments may prevent collapse of an internal crystal structure of the lithium metal oxide particles (e.g., cubic structuring of a layered structure) when removing residual lithium present in the high-Ni-based lithium metal oxide particles.

The cathode active material according to exemplary embodiments may include high-Ni-based lithium metal oxide particles having a small amount of residual lithium while stably maintaining the internal crystal structure (e.g., the layered structure).

The lithium secondary battery according to exemplary embodiments may exhibit improved life-span characteristics and high temperature stability.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is fast Fourier transform (FFT) images obtained by measuring a change in a crystal structure (change from a layered structure to a cubic structure) of High-Ni-based lithium metal oxide particle before and after washing with water by high-resolution transmission electron microscopy (HR-TEM);

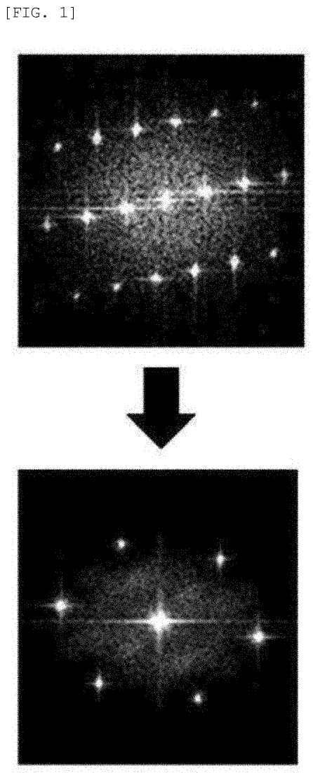

FIG. 2 is a schematic flowchart illustrating a method of manufacturing a cathode active material according to an embodiment;

FIG. 3 is a schematic view schematically illustrating a steam treatment device in which the method of manufacturing a cathode active material according to an embodiment is performed;

FIG. 4 is a schematic view schematically illustrating a ribbon type mixer reaction furnace in which the method of manufacturing a cathode active material according to an embodiment is performed;

FIG. 5 is a schematic view schematically illustrating a conical mixer reaction furnace in which the method of manufacturing a cathode active material according to an embodiment is performed;

FIGS. 6(A) and 6(B) are high-resolution transmission electron microscopy (HR-TEM) images of a lithium metal oxide particle according to Comparative Example 1, which are measured by varying the magnification;

FIGS. 7(A) to 7(D) are high-resolution transmission electron microscopy (HR-TEM) images of a lithium metal oxide particle according to Comparative Example 2. Herein, FIGS. 7(A) and 7(B) are images of a surface of the lithium metal oxide particle of Comparative Example 2, which are measured by varying the magnification, FIG. 7(C) is an image measured in a region of about 200 nm depth from the surface of the lithium metal oxide particle of Comparative Example 2; and FIG. 7(D) is an image of the lithium metal oxide particle of Comparative Example 2, which is obtained by measuring a lower primary particle in contact with the outermost primary particle;

FIGS. 8(A) and 8(B) are high-resolution transmission electron microscopy (HR-TEM) images of a lithium metal oxide particle of Example 1, which are measured by varying the magnification; and

FIG. 9 is a schematic cross-sectional view illustrating a lithium secondary battery according to exemplary embodiments.

### DETAILED DESCRIPTION OF THE INVENTION

As used herein, the term “lithium metal oxide” may refer to an oxide including lithium (Li) and at least one metal element other than lithium.

As used herein, “A or B” may refer to A alone, B alone, and a combination of A and B.

As used herein, the term “layered crystal structure” and “layered structure” may refer to a hexagonal-NaFeO₂ crystal structure having a space group R-3m in which a Li layer and an oxide layer including at least one metal element other than Li continuously intersect each other.

As used herein, the term “cubic crystal structure” and “cubic structure” may collectively refer to crystal structures other than the crystal structure of a rhombohedral phase capable of maintaining a reversible reaction between intercalation and deintercalation of lithium ions. The cubic crystal structure may refer to a crystal structure such as NiO in the case of Ni-based lithium metal oxide particle as an example.

For example, the layered structure and the cubic structure can be confirmed by measuring the lithium metal oxide particle with high-resolution transmission electron microscopy (HR-TEM) and analyzing the lithium metal oxide particle by fast Fourier transform (FFT) analysis.

Hereinafter, the present invention will be described in more detail.

<Method of Manufacturing Cathode Active Material for Lithium Secondary Battery>

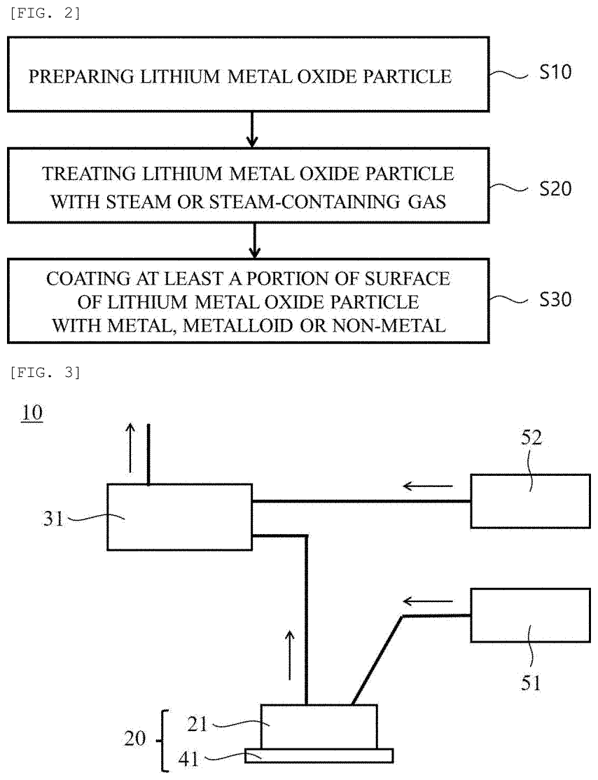

FIG. 2 is a schematic flowchart illustrating a method of manufacturing a cathode active material according to exemplary embodiments.

The method of manufacturing a cathode active material according to exemplary embodiments may include preparing lithium metal oxide particles (e.g., S10), and treating the lithium metal oxide particles with steam or a steam-containing gas (e.g., S20).

The method of manufacturing a cathode active material according to an embodiment may include treating the lithium metal oxide particles with the steam or steam-containing gas, instead of washing the lithium metal oxide with water. Accordingly, it is possible to induce the crystal structure to be changed only in a specific region of the lithium metal oxide particles, while reducing an amount of residual lithium present in the lithium metal oxide particles.

For example, it is possible to prevent a change of a crystal structure inside the lithium metal oxide particles (e.g., cubic structuring of a layered structure), and thus to improve life-span characteristics and high temperature stability of the secondary battery.

Hereinafter, the step S10 will be described in more detail.

In one embodiment, the lithium metal oxide particle may be layered-based lithium metal oxide particle including a layered structure.

In one embodiment, the lithium metal oxide particle may include nickel.

In some embodiments, the lithium metal oxide particle may include nickel, cobalt, and manganese.

In one embodiment, the lithium metal oxide particle may include 80 mol % or more of nickel based on a total number of moles of all elements except for lithium and oxygen.

In one embodiment, the lithium metal oxide particle may be represented by Formula 1 below.

LiₓNiₐCo_{b}M_{c}O_{y} [Formula 1]

In Formula 1, M may be at least one of Al, Zr, Ti, B, Mg, Mn, Ba, Si, Y, W and Sr, and x, y, a, b and c may be a range of 0.9≤x≤1.2, 1.9≤y≤2.1, 0.8≤a≤1, 0≤c/(a+b)≤0.13 and 0≤c≤0.11, respectively.

In some embodiments, in Formula 1, a may satisfy 0.83≤a≤1, 0.85≤a≤1, 0.88≤a≤1, or 0.90≤a≤1.

In some embodiments, the lithium metal oxide particle may further include a doping element. For example, the doping element may include at least one of Al, Ti, Ba, Zr, Si, B, Mg, P, Sr, W and La.

For example, the lithium metal oxide particle may have a structure of secondary particle in which a plurality of primary particles are aggregated.

In one embodiment, the primary particles may have an average particle diameter (D₅₀) of 0.5 to 1.2 μm, and the secondary particles may have an average particle diameter (D₅₀) of 9 to 17 μm.

For example, the average particle diameter D₅₀ may be defined as a particle diameter based on 50% of a cumulative volume distribution according to the particle diameter.

For example, the average particle diameter D₅₀ may be measured by a laser diffraction method using a diffraction particle size measuring device.

Hereinafter, the step S20 will be described in more detail.

In one embodiment, the step S20 may be a step of treating the lithium metal oxide particles with the steam or steam-containing gas without water washing treatment (i.e., treatment with water).

The method of manufacturing a cathode active material according to an embodiment may not include the conventional water washing treatment process.

For example, by the step S20, residual lithium (lithium impurities, for example, LiOH, Li₂CO₃, etc.) present in the lithium metal oxide particles may be removed.

For example, the removal of the residual lithium may mean that at least some of the residual lithium present in the lithium metal oxide particles are removed, such that the amount of residual lithium present in the lithium metal oxide particles is reduced.

In one embodiment, the steam-containing gas may include at least one of oxygen (O₂) gas, nitrogen (N₂) gas, and argon (Ar) gas together with steam.

In one embodiment, the step S20 may include leaving the lithium metal oxide particles in a closed space under an atmosphere of steam or a steam-containing gas for a predetermined time.

In one embodiment, the step S20 may include leaving the lithium metal oxide particles in a space, etc. of an atmosphere through which the steam or steam-containing gas passes (e.g., an atmosphere in which the steam or steam-containing gas input into a reaction furnace is remained in the reaction furnace for a predetermined time, and then discharged to an outside of the reaction furnace).

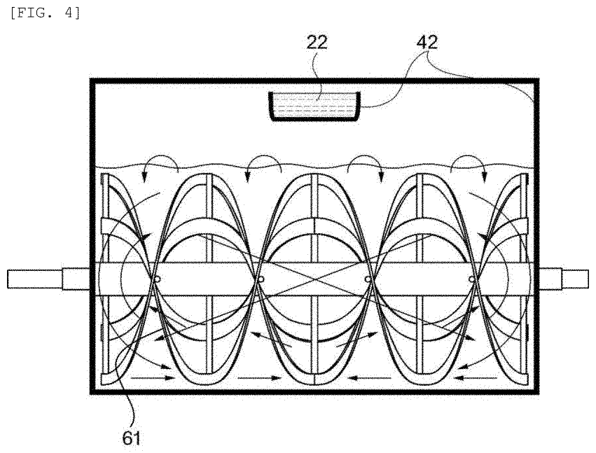

FIG. 3 is a schematic view schematically illustrating a steam or steam-containing gas treatment device 10 (hereinafter, abbreviated to a ‘steam treatment device’) in which the method of manufacturing a cathode active material according to an exemplary embodiment may be performed.

In one embodiment, the step S20 may be performed in the steam treatment device 10.

Referring to FIG. 3, the steam treatment device 10 may include a steam supply device 20 and a reaction furnace 31.

For example, the steam supply device 20 and the reaction furnace 31 may be connected with each other by a pipe or the like. For example, the lithium metal oxide particles may be loaded into the reaction furnace 31, and steam may be input into the reaction furnace 31 using the steam supply device 20. For example, steam treatment may be performed on the lithium metal oxide particles by the steam input into the reaction furnace 31.

In some embodiments, the steam supply device 20 may include a moisture supply source 21 and a heating device 41. For example, moisture provided from the moisture supply source 21 may be vaporized by the heating device 41 and input into the reaction furnace 31.

For example, the steam supply device 20 may employ devices known in the art without limitation thereof. For example, the steam supply device 20 may be a device for generating steam by heating, a device for generating steam in an aerosol form by ultrasonic vibration or the like.

For example, the moisture supply source 21 may be water (e.g., distilled water), which may be provided in a receiving unit such as a water bath.

In one embodiment, when treating the lithium metal oxide particles with the steam-containing gas, the steam treatment device 10 may further include a first gas supply device 51. For example, the first gas supply device 51 and the steam supply device 20 may be connected with each other by the pipe or the like.

In some embodiments, the steam treatment device 10 may also include a second gas supply device 52 capable of providing gas directly to the reaction furnace 31 without going through the moisture supply source 21. In this case, a content of steam in the reaction furnace 31 may be more easily controlled.

In some embodiments, the first gas supply device 51 and the second gas supply device 52 may include a mass flow controller (MFC) to smoothly control a flow rate of the gas.

In some embodiments, the step S20 may include loading the lithium metal oxide particles into the reaction furnace 31; passing the gas provided from the first gas supply device 51 through the moisture supply source 21; and inputting the gas that has passed through the moisture supply source 21 into the reaction furnace 31.

For example, the water-containing gas may be generated while the gas provided from the first gas supply device 51 passes through the moisture supply source 21. Thereafter, when the water-containing gas is input into the reaction furnace 31, the steam-containing gas may be generated by a high heat in the reaction furnace.

In one embodiment, the step S20 may be performed at a temperature of 100° C. or higher, for example, 100° C. or higher and less than 800° C. For example, the temperature of the reaction furnace 31 may satisfy the above-described temperature range. For example, moisture treatment at a temperature at which it is difficult to provide steam (e.g., about 30° C. to 70° C.) is humidification treatment, and an effect of removing the residual lithium present in the lithium metal oxide particles may be deteriorated.

In some embodiments, the step S20 may be performed at 100° C. or higher, and the steam or the steam-containing gas may contain hydroxyl radicals.

In one embodiment, the step S20, may include increasing a material temperature of the lithium metal oxide particles; and spraying water on the lithium metal oxide of which the material temperature is increased.

For example, increasing the material temperature of the lithium metal oxide particles may mean increasing the temperature of the lithium metal oxide particles themselves.

For example, when spraying water on the lithium metal oxide particles with the increased material temperature, the sprayed droplets may be converted into steam in an instant before coming into contact with the lithium metal oxide particles. Accordingly, the lithium metal oxide particles may be substantially subjected to steam treatment.

For example, as a method of increasing the material temperature of the lithium metal oxide particles, heat treatment methods known in the art may be employed without particular limitation thereof. For example, the material temperature of the lithium metal oxide particles may be increased by a heat treatment device described below.

In some embodiments, the material temperature of the lithium metal oxide particles with the increased material temperature may be 100 to 500° C., and more preferably, 100 to 300° C.

In one embodiment, the step S20 may include: loading the lithium metal oxide particles into a reaction furnace having an internal temperature of 100° C. or higher; and spraying water on the lithium metal oxide particles.

For example, the lithium metal oxide particles are loaded into the reaction furnace 31 and the internal temperature of the reaction furnace is set to the above temperature range, then water may be sprayed on the lithium metal oxide particles. In this case, the sprayed droplets may be converted into steam in an instant. Accordingly, the lithium metal oxide particles may be subjected to the steam treatment. In some embodiments, the internal temperature of the reaction furnace 31 may be 100° C. or higher and less than 800° C., and more preferably, 100 to 500° C.

For example, as the reaction furnace 31, heat treatment devices known in the art may be employed without limitation thereof.

For example, the reaction furnace 31 is a reactor having a structure through which steam or a steam-containing gas passes (e.g., a structure in which the steam or a steam-containing gas input into the reaction furnace is remained in the reaction furnace for a predetermined time, and then discharged to an outside of the reaction furnace), and may be a tube type calcination furnace, a box type calcination furnace, a rotary kiln (RK), a roller hearth kiln (RHK), a fluidized bed reactor and the like. Alternatively, the reaction furnace 31 is a reactor having a structure capable of implementing a reaction between the steam or the steam-containing gas and the lithium metal oxide particles in a closed space, and may be any one selected from an autoclave, a ribbon mixer, a conical mixer and the like.

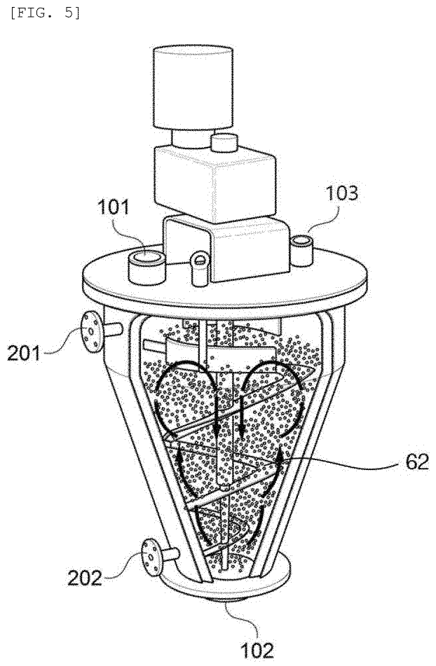

In some embodiments, the reaction furnace 31 may include a steam supply device 20 therein. For example, as shown in FIG. 4, the reaction furnace 31 may be provided with a moisture supply source 22 and a heating device 42 therein. In this case, the process may be further simplified.

In one embodiment, the step S20 may be performed while stirring the lithium metal oxide particles loaded in the reaction furnace 31. In this case, steam treatment may be efficiently performed on the entire portion of the lithium metal oxide particles.

In some embodiments, as shown in FIG. 4, the reaction furnace 31 may be a ribbon type mixer reaction furnace.

For example, the ribbon type mixer reaction furnace may include the moisture supply source 22, the heating device 42, and a ribbon type blade 61 therein.

For example, the lithium metal oxide particles loaded into the ribbon type mixer reaction furnace may be stirred by the ribbon type blade 61. For example, the lithium metal oxide particles may be subjected to steam treatment with steam provided from the moisture supply source 22 and the heating device 42 while being stirred. In this case, steam treatment may be efficiently performed on the entire portion of the lithium metal oxide particles.

In some embodiments, when using the ribbon mixer type reaction furnace, the steam treatment device 10 may not separately include the external steam supply device 20.

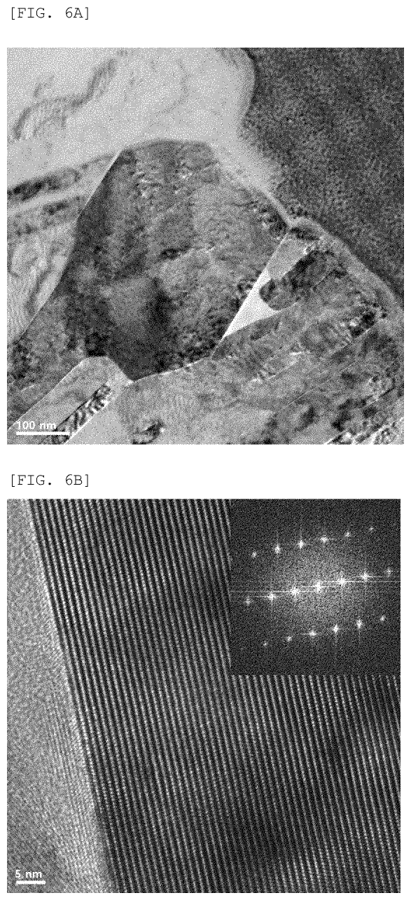

In some embodiments, as shown in FIG. 5, the reaction furnace 31 may be a conical mixer reaction furnace.

For example, the conical mixer reaction furnace may include an inlet 101 and an outlet 102 for lithium metal oxide particles, an inlet 103 for steam and an impeller 62 (e.g., a helical impeller).

In some embodiments, the conical mixer reaction furnace may further include an inlet 201 and an outlet 202 for a heating medium for controlling the internal temperature thereof.

For example, the lithium metal oxide particles loaded in the conical mixer reaction furnace may be stirred by the helical impeller 62. For example, the lithium metal oxide particles may be subjected to steam treatment by the steam input into the inlet 103 for steam while being stirred. In this case, steam treatment may be efficiently performed on the entire portion of the lithium metal oxide particles.

According to an embodiment, in the step S20, a total amount of steam or steam-containing gas supplied into the reaction furnace 31 may be 1 to 10% by weight (‘wt. %’) based on a total weight of the lithium metal oxide particles loaded into the reaction furnace 31. In this case, it is possible to significantly reduce the amount of residual lithium present in the lithium metal oxide particles, while preventing a change in the internal crystal structure of the lithium metal oxide particles.

In one embodiment, the step S20 may be performed for 1 to 12 hours. In this case, it is possible to significantly reduce the amount of residual lithium present in the lithium metal oxide, while preventing a change in the internal crystal structure of the lithium metal oxide particles.

In one embodiment, the step S20 may include supplying an oxidant. In this case, the amount of residual lithium present in the lithium metal oxide particles may be further reduced.

In some embodiments, the oxidant may include at least one of hydrogen peroxide (H₂O₂), potassium permanganate (KMnO₄), and sodium peroxide disulfate (Na₂S₂O₈). In this case, by increasing the reactivity between the steam and the lithium metal oxide particles, the effect of removing the residual lithium may be further improved.

In some embodiments, the oxidant may be input into the moisture supply source 21. For example, the moisture supply source 21 may be water (e.g., distilled water), and the oxidant may be included in an amount of 0.1 to 5 wt. % based on the total weight of the moisture supply source 21. When the oxidant is included in an amount more than 5 wt. %, lithium present in the lithium metal oxide particles may be reduced. In this case, the reduced lithium may react with the steam to cause an explosion.

In one embodiment, after the step S20, the method may further include coating at least a portion of the surface of the lithium metal oxide particles with metal, metalloid or non-metal (e.g., S30). In this case, it is possible to secure stabilization effects of not only an internal structure but also the surface of the lithium metal oxide particles. For example, it is possible to prevent decomposition and oxidation of the electrolyte due to contact of the lithium metal oxide particles with the electrolyte. Thereby, it is possible to further improve the life-span characteristics of the secondary battery.

For example, a coating layer having a plurality of (discontinuous) island shapes or a coating layer having a (continuous) sea shape may be formed on the surface of the lithium metal oxide particles by step S30.

For example, in the step S30, dry coating or wet coating of a coating source including metal, metalloid or non-metal may be performed.

In some embodiments, the coating source may include at least one of aluminum (Al), zirconium (Zr) and titanium (Ti), sulfur (S) and boron (B).

For example, the coating source may include at least one of sodium aluminate (NaAlO₂), azirconium nitrate (Zr(NO₃)₄), sodium peroxide disulfate (Na₂S₂O₈) and boric acid (H₃BO₃).

In some embodiments, the step S30 may include coating the lithium metal oxide particles with boron (B). In this case, a lithium-boron-oxygen (Li—B—O) coating layer may be formed on at least a portion of the surface of the lithium metal oxide particles. Side reactions between the lithium metal oxide particles and the electrolyte may be prevented by the Li—B—O coating layer. In addition, the performance of the secondary battery may be further improved by providing a passage for lithium ions to move.

For example, in the step S20, a change in the crystal structure (e.g., cubic structuring of the layered structure) may proceed only in a specific region of the lithium metal oxide particle (e.g., a region having a thickness of less than 200 nm from the surface of the lithium metal oxide particle). Accordingly, in the step S30, the coating layer may be more uniformly formed, such that the performance of the secondary battery may be more remarkably improved.

In one embodiment, the step S20 may include supplying a coating source including metal, metalloid or non-metal. In this case, a coating layer including metal, metalloid or non-metal may be formed along with removal of the residual lithium present in the lithium metal oxide particles. Accordingly, the process may be further simplified.

<Cathode Active Material for Lithium Secondary Battery>

The cathode active material according to exemplary embodiments may include lithium metal oxide particle having a layered structure and a cubic structure.

In one embodiment, the lithium metal oxide particle may include 80 mol % or more of nickel based on the total number of moles of all elements except for lithium and oxygen.

In some embodiments, the nickel content in the lithium metal oxide particle may be 83 mol % or more, preferably, 85 mol % or more, more preferably, 88 mol % or more, and even more preferably, 90 mol % or more based on the total number of moles of all elements except for lithium and oxygen.

In one embodiment, the lithium metal oxide particle may include a cubic structure only in a specific region, unlike lithium metal oxide particle subjected to the conventional water washing treatment (e.g., liquid water treatment). Accordingly, it is possible to implement a secondary battery having better life-span characteristics and high temperature stability.

In one embodiment, the lithium metal oxide particle may include the cubic structure only in a region having a thickness of less than 200 nm from the surface of the particles when analyzing the crystal structure by high-resolution transmission electron microscopy (HR-TEM).

In some embodiments, the lithium metal oxide particle may include a cubic structure only in a region having a thickness of 150 nm or less, 100 nm or less, 50 nm or less, or 25 nm or less from the surface thereof when analyzing the crystal structure by HR-TEM. In this case, life-span characteristics and high temperature stability of the secondary battery may be further improved.

In some embodiments, the lithium metal oxide particle may include a cubic structure only in a region having a thickness of 150 nm, 100 nm, 50 nm or 25 nm from the surface thereof when analyzing the crystal structure by HR-TEM. In this case, life-span characteristics and high temperature stability of the secondary battery may be further improved. In one embodiment, the lithium metal oxide particle may have a specific surface area of 0.25 m²/g or less. In this case, the side reactions between the lithium metal oxide particle and the electrolyte may be suppressed. In addition, it is possible to implement a secondary battery having further improved high-temperature stability.

For example, the specific surface area may be measured using a BET measuring instrument (ASAP2420, Micrometrics Co.), according to a gas adsorption/desorption method. For example, since the lithium metal oxide particle synthesized by the method of Preparative Example 1 to be described below have a small specific surface area, there is an advantage in that the amount of residual lithium present in the lithium metal oxide particle may be reduced without a separate water washing treatment.

In some embodiments, the lithium metal oxide particles may have a specific surface area of 0.05 m²/g or more. In this case, smooth mobility of lithium ions may be secured.

In one embodiment, the residual lithium may include lithium hydroxide (LiOH), lithium carbonate (Li₂CO₃) and the like.

In one embodiment, a total amount of residual lithium present in the lithium metal oxide particle may be 6000 ppm or less, preferably, 4500 ppm or less, more preferably, 3000 ppm or less, and even more preferably, 2500 ppm or less based on the weight of the lithium metal oxide particle.

For example, the total amount of residual lithium may be a total amount of lithium hydroxide and lithium carbonate.

For example, the total amount of residual lithium may mean the total amount of residual lithium measured without the conventional water washing treatment (e.g., liquid water treatment).

In some embodiments, the total amount of residual lithium present in the lithium metal oxide particle may be 1000 ppm or more.

In some embodiments, the amount of LiOH present in the lithium metal oxide particle may be 500 to 3000 ppm without water washing treatment.

In some embodiments, the amount of Li₂CO₃ present in the lithium metal oxide particle may be 500 to 3000 ppm without water washing treatment.

The cathode active material may further include a coating layer which formed on at least a portion of the surface of the lithium metal oxide particle and includes metal, metalloid and non-metal. In this case, it is possible to secure the stabilization effects of not only an internal structure of the lithium metal oxide particle but also the surface of the lithium metal oxide particle. For example, it is possible to prevent decomposition and oxidation of the electrolyte due to contact of the lithium metal oxide particle with the electrolyte. Thereby, it is possible to further improve the life-span characteristics of the secondary battery.

For example, the coating layer may have the plurality of (discontinuous) island shapes, or the (continuous) sea shape.

In some embodiments, the coating layer may include at least one of aluminum (Al), zirconium (Zr), titanium (Ti), sulfur (S) and boron (B).

In some embodiments, the coating layer may include a lithium-boron-oxygen (Li—B—O). For example, the side reactions between the lithium metal oxide particle and the electrolyte may be prevented by the Li—B—O coating layer. In addition, the performance of the secondary battery may be further improved by providing the passage for lithium ions to move.

<Lithium Secondary Battery>

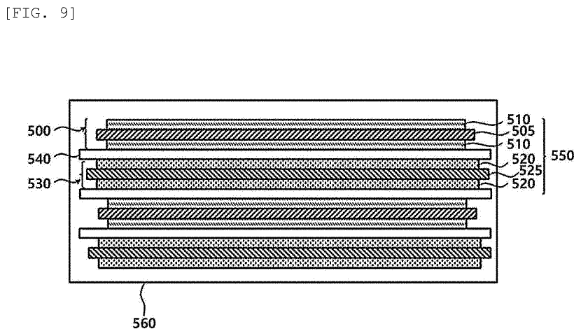

FIG. 9 is a schematic cross-sectional view illustrating a lithium secondary battery according to exemplary embodiments.

Referring to FIG. 9, the lithium secondary battery according to exemplary embodiments may include a cathode 500 and an anode 530 disposed to face the cathode 500.

In one embodiment, the lithium secondary battery may further include a separation membrane 540 interposed between the cathode 500 and the anode 530.

For example, the cathode 500 may include a cathode current collector 505 and a cathode active material layer 510 on the cathode current collector 505.

For example, the cathode active material layer 510 may include the cathode active material including the above-described lithium metal oxide particles, a cathode binder, and if necessary, a conductive material.

For example, the cathode 500 may be prepared by mixing and stirring the cathode active material, the cathode binder, and the conductive material, etc. in the solvent to prepare a cathode slurry, and then coating the cathode current collector 105 with the cathode slurry, followed by drying and rolling the same.

For example, the cathode current collector 505 may include stainless steel, nickel, aluminum, titanium, copper or an alloy thereof, and preferably, includes aluminum or an aluminum alloy.

For example, the cathode binder may serve to ensure the cathode active material particles to be reliably adhered to each other, as well as the cathode active material and the cathode current collector to be reliably adhered to each other. For example, the cathode binder may include an organic binder such as vinylidene fluoride-hexafluoropropylene copolymer (PVDF-co-HFP), polyvinylidene fluoride (PVDF), polyacrylonitrile, polymethyl methacrylate, etc., or an aqueous binder such as styrene-butadiene rubber (SBR), and may be used together with a thickener such as carboxymethyl cellulose (CMC). More preferably, the cathode binder may be a PVDF-based binder.

For example, the conductive material may serve to facilitate transfer of electrons between the cathode active material particles. For example, the conductive material may include a carbon-based conductive material such as graphite, carbon black, graphene, and carbon nanotubes; or a metal-based conductive material including tin, tin oxide, titanium oxide, or a perovskite material such as LaSrCoO₃, and LaSrMnO₃.

For example, the anode 530 may include an anode current collector 525 and an anode active material layer 520 on the anode current collector 525.

For example, the anode active material layer 520 may include an anode active material, and if necessary, an anode binder and a conductive material.

For example, the anode 530 may be prepared by mixing and stirring the anode active material, the anode binder, the conductive material, etc. in a solvent to prepare an anode slurry, and then coating the anode current collector 525 with the anode slurry, followed by drying and rolling the same.

For example, the anode current collector 525 may include gold, stainless steel, nickel, aluminum, titanium, copper or an alloy thereof, and preferably, includes copper or a copper alloy.

For example, the anode active material may be a material capable of intercalating and deintercalating lithium ions. For example, the anode active material may include a carbon-based material such as crystalline carbon, amorphous carbon, carbon composite, or carbon fiber, etc.; an Si-based material such as Si, SiOx (0<x<2), Si/C, SiO/C, and Si-metal; a lithium alloy and the like. For example, the amorphous carbon may be hard carbon, cokes, mesocarbon microbead (MCMB) calcined at a temperature of 1500° C. or lower, mesophase pitch-based carbon fiber (MPCF) or the like. The crystalline carbon may be, for example, natural graphite, graphite cokes, graphite MCMB, graphite MPCF or the like. The lithium alloy may include, for example, a metal element such as aluminum, zinc, bismuth, cadmium, antimony, silicon, lead, tin, gallium, and indium.

For example, the anode binder and the conductive material may be substantially the same as or similar to the cathode binder and the conductive material. For example, the anode binder may be an aqueous binder such as styrene-butadiene rubber (SBR) for consistency with the carbon-based active material, and may be used together with a thickener such as carboxymethyl cellulose (CMC).

For example, the separation membrane 540 may include a porous polymer film made of a polyolefin polymer such as ethylene homopolymer, propylene homopolymer, ethylene/butene copolymer, ethylene/hexene copolymer, ethylene/methacrylate copolymer or the like. Alternatively, the separation membrane 540 may include a nonwoven fabric made of glass fiber having a high melting point, polyethylene terephthalate fiber or the like.

For example, an electrode cell 500 may be formed by including the cathode 500, the anode 530 and the separation membrane 540. For example, a plurality of electrode cells may be laminated to form an electrode assembly. For example, the electrode assembly may be formed by winding, lamination, folding, or the like of the separation membrane 540.

For example, the electrode assembly may be housed in an outer case 560 together with the electrolyte to form a lithium secondary battery. The electrolyte may be a lithium salt, and may be included in the outer case in a non-aqueous electrolyte state together with an organic solvent.

For example, the lithium salt may be represented by Li⁺X⁻. For example, an anion (X—) of the lithium salt may be F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻ and the like.

For example, the organic solvent may include propylene carbonate (PC), ethylene carbonate (EC), diethyl carbonate (DEC), dimethyl carbonate (DMC), ethylmethyl carbonate (EMC), methylpropyl carbonate, dipropyl carbonate, dimethyl sulfoxide, acetonitrile, dimethoxyethane, diethoxyethane, vinylene carbonate, sulforane, γ-butyrolactone, propylene sulfite, tetrahydrofurane and the like.

For example, the lithium secondary battery may be manufactured in a cylindrical shape, a square shape, a pouch shape or a coin shape.

Hereinafter, preferred examples and comparative examples of the present invention will be described. However, the following examples are only preferred examples of the present invention, and the present invention is not limited thereto.

### Preparing a Lithium Metal Oxide Particle

### Preparative Example 1

A mixed solution was prepared in which NiSO₄, CoSO₄, and MnSO₄ were mixed in a molar ratio of 83:11:6, respectively, using distilled water from which internal dissolved oxygen was removed by bubbling with nitrogen gas (N₂) for 24 hours.

The mixed solution was input into a batch reactor at 50° C., and a co-precipitation reaction was performed for 300 hours using NaOH and NH₃H₂O as a precipitant and a chelating agent to form NCM composite hydroxide having an average particle diameter (D₅₀) of 10 to 20 μm, and a BET of less than 3 m²/g.

The NCM composite hydroxide was dried at 80° C. for 12 hours and then again dried at 110° C. for 12 hours. Lithium hydroxide was added thereto so that the molar ratio of the NCM composite hydroxide and LiOH was 1:1.01, and the mixture was stirred and mixed uniformly for 5 minutes.

The prepared mixture was input into a calcination furnace, heated to 710° C. at a heating rate of 2° C./min, and maintained at 710° C. for 10 hours. Oxygen gas was continuously passed during heating and maintaining the temperature.

After the calcination is completed, the mixture was naturally cooled to room temperature, followed by grinding and classification to obtain lithium metal oxide particles (LiNi_{0.83}C_{0.11}Mn_{0.06}O₂) of Preparative Example 1 having an average particle diameter (D₅₀) of about 11 μm, and a BET of 0.21 m²/g.

### Preparative Example 2

A mixed solution was prepared in which NiSO₄, CoSO₄, and MnSO₄ were mixed in a molar ratio of 83:11:6, respectively, using distilled water from which internal dissolved oxygen was removed by bubbling with nitrogen gas (N₂) for 24 hours.

The mixed solution was put into a continuous stirred-tank reactor (CSTR) at 50° C., and a co-precipitation reaction was performed for 30 hours using NaOH and NH₃H₂O as a precipitant and a chelating agent to form NCM composite hydroxide having an average particle diameter (D₅₀) of 10 to 20 μm, and a BET of 10 m²/g or more.

The NCM composite hydroxide was dried at 80° C. for 12 hours and then again dried at 110° C. for 12 hours. Lithium hydroxide was added thereto so that the molar ratio of the NCM composite hydroxide and LiOH was 1:0.8, and the mixture was stirred and mixed uniformly for 5 minutes.

The prepared mixture was input into a calcination furnace, heated to 780° C. at a heating rate of 2° C./min, and maintained at 780° C. for 10 hours. Oxygen gas was continuously passed at a flow rate of 10 mL/min during heating and maintaining the temperature.

In order to match the molar ratio of Li with a total molar ratio of Ni, Co and Mn to 1:1 chemical quantitative ratio, an additional Li was added to the prepared primary calcined material (Li_{0.8}Ni_{0.83}C_{0.11}Mn_{0.06}O₂) in 0.2 molar ratio, followed by uniformly stirring and mixing the mixture.

The prepared mixture was input into a calcination furnace, heated to 710° C. at a heating rate of 2° C./min, and maintained at 710° C. for 10 hours. Oxygen gas was continuously passed at a flow rate of 10 mL/min during heating and maintaining the temperature.

After the calcination is completed, the mixture was naturally cooled to room temperature, followed by grinding and classification to obtain lithium metal oxide particles (LiNi_{0.83}C_{0.11}Mn_{0.06}O₂) of Preparative Example 2 having an average particle diameter (D₅₀) of about 13 μm, and a BET of 0.5 m²/g.

### Steam-Containing Gas Treatment, Water-Washing Treatment or Humidification Treatment for Lithium Metal Oxide Particle

### Example 1

The lithium metal oxide particles were subjected to steam-containing gas treatment using the steam treatment device 10 shown in FIG. 3 (the second gas supply device 52 is not used).

The lithium metal oxide particles of Preparative Example 1 were loaded onto a plate in the reaction furnace 31 (tube type calcination furnace). The internal temperature of the calcination furnace was set to be 300° C.

Using the first gas supply device 51, oxygen gas was input into the calcination furnace while passing through the moisture supply source 21 (distilled water provided in a water bath) at a flow rate of 100 mL/min.

The oxygen gas was converted into a water-containing gas by passing through the water bath, and the water-containing gas was input into the calcination furnace to be converted into a steam-containing gas, such that the lithium metal oxide particles loaded in the calcination furnace were subjected to steam treatment.

After the steam treatment was performed for 6 hours, the particles were dried at 80° C. for 1 hour to prepare lithium metal oxide particles on which the steam treatment was completed.

### Example 2

Steam treatment was performed in the ribbon type mixer reaction furnace shown in FIG. 4.

The reaction furnace is equipped with the ribbon type blade 61, the moisture supply source 22 and the heating device 42 therein. Accordingly, unlike the steam treatment device shown in FIG. 3, the furnace may not be provided with a separate external steam supply device.

The lithium metal oxide particles of Preparative Example 1 were loaded into the reaction furnace to an extent that the ribbon type blade 61 was sufficiently submerged. Thereafter, steam treatment was performed on the loaded lithium metal oxide particles while stirring the same using the ribbon type blade 61.

The moisture supply source 22 was prepared as distilled water in a receiving unit provided at an upper portion of the reaction furnace. At this time, the distilled water was prepared in an amount of 5 wt. % based on the total weight of the lithium metal oxide particles loaded in the reaction furnace. The distilled water was vaporized by the heating device 42, and steam treatment was performed on the lithium metal oxide particles. The internal temperature of the reaction furnace was maintained at 275° C. by the heating device 42.

After the steam treatment was performed for 6 hours, vacuum drying was performed on the particles at the same temperature for 6 hours to prepare lithium metal oxide particles on which the steam treatment was completed.

### Example 3

Lithium metal oxide particles treated with steam were prepared by performing the same procedures as described in Example 2, except that the lithium metal oxide particles of Preparative Example 2 were used.

### Example 4

Steam treatment was performed in the conical mixer reaction furnace shown in FIG. 5.

The reaction furnace is provided with the inlet 101 and the outlet 102 for lithium metal oxide particles, the inlet 103 for steam, and the inlet 201 and the outlet 202 for heating medium for controlling the internal temperature of the reaction furnace. In addition, the reaction furnace is provided with a helical impeller 62 therein, such that the lithium metal oxide particles may be subjected to steam treatment while stirring the same.

Since an inner wall of the reaction furnace is coated with tungsten carbide (WC), even when inputting the oxidant into the reaction furnace, it is possible to prevent corrosion of the reaction furnace due to the oxidant.

The lithium metal oxide particles of Preparative Example 2 were loaded into the reaction furnace to an extent that the helical impeller 62 was sufficiently submerged, and the internal temperature of the reaction furnace was maintained at 275° C. while stirring the same.

1 wt. % of hydrogen peroxide (H₂O₂) was added to the moisture supply source (distilled water) based on the total weight of the moisture supply source.

Distilled water containing hydrogen peroxide was vaporized using the heating device, and then the steam was input into the reaction furnace. The lithium metal oxide particles were subjected to steam treatment by the hydrogen peroxide-containing steam input into the reaction furnace.

The steam treatment was performed for 10 hours, and vacuum drying was performed for 6 hours while decreasing the temperature, thus to prepare lithium metal oxide particles treated the steam.

### Example 5

Cathode active material particles treated with steam were prepared by performing the same procedures as described in Example 4, except that sodium peroxide disulfate (Na₂S₂O₈) was added instead of hydrogen peroxide (H₂O₂).

### Comparative Example 1

The lithium metal oxide particles of Preparative Example 1 were used without a separate treatment.

### Comparative Example 2

50 g of the lithium metal oxide particles of Preparative Example 1 were put in 50 ml of distilled water (pH: 7), stirred and washed with water, and then filtered until the pH value was not changed.

Thereafter, the particles were dried at 130° C. for 12 hours to prepare lithium metal oxide particles washed with water.

### Comparative Example 3

Air at a temperature of 20° C. and a relative humidity of 21% was flowed on 20 g of the lithium metal oxide particles of Preparative Example 1 at a rate of 80 ft/min, such that a reaction was carried out for 6 hours.

Thereafter, the particles were dried at 130° C. for 1 hour to prepare lithium metal oxide on which humidification treatment was performed.

### Comparative Example 4

The lithium metal oxide particles of Preparative Example 2 were used without a separate treatment.

### Comparative Example 5

50 g of the lithium metal oxide particles of Preparative Example 2 were put in 50 ml of distilled water (pH: 7), stirred and washed with water, and then filtered until the pH value was not changed.

Thereafter, the particles were dried at 130° C. for 12 hours to prepare the lithium metal oxide particles washed with water.

### Preparing a Cathode Active Material Particle Including a Coating Layer and Preparing a Secondary Battery

### Example 6

(1) Coating

50 g of the lithium metal oxide particles of Example 1 and 800 ppm of H₃BO₃ were put into a dry high-speed mixer and uniformly mixed for 5 minutes.

After putting the obtained mixture in a calcination furnace, the temperature of the calcination furnace was increased to 275° C. at a heating rate of 2° C./min, and the mixture was maintained at 275° C. for 10 hours. Oxygen was passed through at a flow rate of 10 mL/min during heating and maintenance.

After the calcination is completed, the mixture was naturally cooled to room temperature, followed by grinding and classification to prepare cathode active material particles including a boron coating layer.

(2) Manufacturing a Secondary Battery

A cathode slurry was prepared by mixing the cathode active material particles, carbon black, and PVDF in a weight ratio of 92:5:3.

The prepared cathode slurry was uniformly applied to an aluminum foil having a thickness of 15 μm, followed by vacuum drying at 130° C. to prepare a cathode.

An electrode assembly was formed by including the cathode, a lithium foil as a counter electrode, and a porous polyethylene (thickness: 21 μm) as a separation membrane interposed between the cathode and the lithium foil.

Using the electrode assembly, and a liquid electrolyte obtained by dissolving LiPF₆ at a concentration of 1.0M in a solvent in which ethylene carbonate and ethylmethyl carbonate are mixed in a volume ratio of 3:7, a secondary battery having a coin half-cell shape was manufactured according to the conventionally known manufacturing process.

### Example 7

A secondary battery was manufactured by performing same procedures as described in Example 6, except that the lithium metal oxide particles prepared in Example 2 were used.

### Example 8

Without taking out the lithium metal oxide particles prepared in Example 3 from the reaction furnace, 800 ppm of H₃BO₃ was additionally input into the reaction furnace and stirred.

The temperature of the reaction furnace was increased to 275° C., followed by performing a reaction for 10 hours to prepare cathode active material particles including a boron coating layer.

A secondary battery was manufactured by performing the same procedures as described in Example 6, except that the cathode active material particles were used.

### Example 9

50 g of the lithium metal oxide particles prepared in Example 3 and 800 ppm of H₃BO₃ were put into a dry high-speed mixer and uniformly mixed for 5 minutes.

The obtained mixture was put in a calcination furnace, then the temperature of the calcination furnace was increased to 275° C. at a heating rate of 2° C./min, and the mixture was maintained at 275° C. for 5 hours. Oxygen was passed through at a flow rate of 100 mL/min during heating and maintenance.

After the calcination is completed, the mixture was naturally cooled to room temperature, followed by grinding and classification to prepare cathode active material particles including a boron coating layer.

A secondary battery was manufactured by performing the same procedures as described in Example 6, except that the cathode active material particles coated with boron were used.

### Example 10

Without taking out the lithium metal oxide particles prepared in Example 4 from the reaction furnace, 800 ppm of H₃BO₃ was additionally input into the reaction furnace and stirred.

The temperature of the reaction furnace was increased to 275° C., followed by performing a reaction for 10 hours to prepare cathode active material particles including a boron coating layer.

A secondary battery was manufactured by performing the same procedures as described in Example 6, except that the cathode active material particles were used.

### Example 11

Without taking out the lithium metal oxide particles prepared in Example 5 from the reaction furnace, 800 ppm of H₃BO₃ was additionally input into the reaction furnace and stirred.

The temperature of the reaction furnace was increased to 275° C., followed by performing a reaction for 10 hours to prepare cathode active material particles including a boron coating layer.

A secondary battery was manufactured by performing the same procedures as described in Example 6, except that the cathode active material particles were used.

### Example 12

Cathode active material particles including an aluminum coating layer were prepared by performing the same procedures as described in Example 4, except that 2000 ppm of sodium aluminate (NaAlO₂) was input instead of hydrogen peroxide (H₂O₂).

Without taking out the cathode active material particles from the reaction furnace, 800 ppm of H₃BO₃ was additionally input into the reaction furnace and stirred.

The temperature of the reaction furnace was increased to 275° C., followed by performing a reaction for 10 hours to prepare cathode active material particles including the aluminium coating layer and a boron coating layer.

A secondary battery was manufactured by performing the same procedures as described in Example 6, except that the cathode active material particles were used.

### Comparative Example 6

A secondary battery was manufactured by performing same procedure as described in Example 6, except that the lithium metal oxide particles of Comparative Example 2 were used.

### Comparative Example 7

A secondary battery was manufactured by performing same procedure as described in Example 6, except that the lithium metal oxide particles prepared in Comparative Example 3 were used.

### Comparative Example 8

A secondary battery was manufactured by performing same procedure as described in Example 6, except that the lithium metal oxide particles prepared in Comparative Example 4 were used.

### Experimental Example 1: Observation of Change in Crystal Structure

For the lithium metal oxide particles of Examples 1 to 5 and Comparative Examples 1 to 5, it was observed whether the internal crystal structure was changed (e.g., whether cubic structuring of the layered structure occurred).

Cross-sections of the lithium metal oxide particles were analyzed using high-resolution transmission electron microscopy (HR-TEM).

It was confirmed whether the cubic structure was observed only in a region having a thickness of 50 nm from the surface of the lithium metal oxide particles.

When the cubic structure is observed only in the region having a thickness of 50 nm from the surface of the lithium metal oxide particles, it was additionally confirmed whether the cubic structure was observed only in a region having a thickness of 25 nm from the surface thereof.

Evaluation was performed according to the following evaluation criteria, and results thereof are shown in Table 1 below.

When a cubic structure was not observed: Δ

When a cubic structure was observed only in a region having a thickness of 25 nm from the surface: ⊚

When a cubic structure was observed only in a region having a thickness of 50 nm from the surface: ∘

When cubic structures were observed also in other regions: x

### [Experimental Example 2] Measurement of Content of Residual Lithium

Amounts of residual lithium present in the lithium metal oxide particles of Examples 1 to 5 and Comparative Examples 1 to 5 were measured.

2.5 g of lithium metal oxide particles and 100 g of deionized water were put into a 250 mL flask, then the mixture was stirred at a speed of 100 rpm for 10 minutes.

The obtained dispersion was filtered using a flask at reduced pressure, and then 100 g was sampled.

The sampled dispersion was input into an automatic titrator and automatically titrated with 0.1 N HCl with reference to the Wader's method to measure LiOH and Li₂CO₃ values in the dispersion, and results thereof are shown in Table 1 below.

### Experimental Example 3: Measurement of Initial Charge Capacity and Initial Discharge Capacity

For the secondary batteries of Examples 6 to 12 and Comparative Examples 4 to 6, 0.1C CC/CV charge (4.3 V, 0.05C CUT-OFF) and 0.1C CC discharge (3.0 V CUT-OFF) were performed once, then initial charge capacity and discharge capacity were measured.

The measured initial charge capacity and discharge capacity are shown in Table 2 below.

### Experimental Example 4: Measurement of Capacity Retention Rate

For the secondary batteries of Examples 6 to 12 and Comparative Examples 4 to 6, 0.5C CC/CV charge (4.3 V, 0.05C, CUT-OFF) and 1.0C CC discharge (3.0V, CUT-OFF) were repeated 200 times.

The capacity retention rate was calculated as a percentage of a value obtained by dividing the discharge capacity measured at 200 times by the discharge capacity measured at one time.

The calculated capacity retention rates are shown in Table 2 below.

### Experimental Example 5: Measurement of High-Temperature Storage Gas

The secondary batteries of Examples 6 to 12 and Comparative Examples 4 to 6, in which the initial discharge capacity measurement was completed, were fully charged again (0.5C CC/CV charge, 4.3 V, 0.05C CUT-OFF) at room temperature.

After the charging was completed, the secondary battery was disassembled to collect only the cathode. The cathode was housed in a pouch, an electrolyte was injected, and then sealed. At this time, 10 cathodes were housed in the pouch in order to reduce a measurement error in a gas generation amount.

The pouch containing the cathodes housed therein are stored at 60° C. for 4 weeks, and then the gas generation amount was measured.

The gas generation amount was calculated using a difference between a weight of the pouch measured outside a water bath and a weight of the pouch measured inside the water bath using Archimedes' principle.

The calculated amounts of gas generation are shown in Table 2 below.

TABLE 1

| | | | Content | Total | Evaluated |
|---|---|---|---|---|---|
| | Lithium | Content | of | amount of | change in |
| | metal oxide | of LiOH | Li₂CO₃ | lithium | crystal |
| | particles | (ppm) | (ppm) | (ppm) | structure |
| Example 1 | Preparative | 1400 | 1490 | 2890 | ⊚ |
| | Example 1 | | | | |
| Example 2 | Preparative | 1230 | 1150 | 2380 | ⊚ |
| | Example 1 | | | | |
| Example 3 | Preparative | 2680 | 2820 | 5500 | — |
| | Example 2 | | | | |
| Example 4 | Preparative | 1980 | 2200 | 4180 | — |
| | Example 2 | | | | |
| Example 5 | Preparative | 2450 | 2110 | 4260 | — |
| | Example 2 | | | | |
| Comparative | Preparative | 2020 | 1870 | 3890 | Δ |
| Example 1 | Example 1 | | | | |
| Comparative | Preparative | 1200 | 1100 | 2300 | × |
| Example 2 | Example 1 | | | | |
| Comparative | Preparative | 3400 | 3020 | 6420 | — |
| Example 3 | Example 1 | | | | |
| Comparative | Preparative | 3660 | 5760 | 9420 | Δ |
| Example 4 | Example 2 | | | | |
| Comparative | Preparative | 2100 | 1250 | 3350 | × |
| Example 5 | Example 2 | | | | |

TABLE 2

| | | | | | Capacity | Amount |
|---|---|---|---|---|---|---|
| | | | | | retention rate | of gas |
| | Lithium | Initial | Initial | | after 200 | generation |
| | metal | charge | discharge | | cycles at room | at high |
| | oxide | capacity | capacity | Efficiency | temperature | temperature |
| | particles | (mAh/g) | (mAh/g) | (%) | (%) | (ml) |
| Example 6 | Example 1 | 241.0 | 212.3 | 88.0 | 75.0 | 17 |
| Example 7 | Example 2 | 240.8 | 211.9 | 88.0 | 75.5 | 17 |
| Example 8 | Example 3 | 237.5 | 213.5 | 89.9 | 78.3 | 21 |
| Example 9 | Example 3 | 237.5 | 213.3 | 89.8 | 77.3 | 22 |
| Example 10 | Example 4 | 237.0 | 213.0 | 89.9 | 76.3 | 23 |
| Example 11 | Example 5 | 237.3 | 213.8 | 90.1 | 80.2 | 18 |
| Example 12 | Example 12 | 237.7 | 214.7 | 90.3 | 81.0 | 19 |
| Comparative | Comparative | 241.5 | 212.0 | 87.7 | 68.0 | 43 |
| Example 6 | Example 2 | | | | | |
| Comparative | Comparative | 238.0 | 208.5 | 87.6 | 70.0 | 40 |
| Example 7 | Example 3 | | | | | |
| Comparative | Comparative | 237.0 | 209.7 | 88.5 | 65.5 | 40 |
| Example 8 | Example 4 | | | | | |

As can be seen from Table 1 above, the lithium metal oxide particles of Comparative Example 1, which were not subjected to a separate water washing treatment, exhibited a high amount of residual lithium to 3890 ppm. On the other hand, the lithium metal oxide particles of Example 1, which were subjected to the steam treatment, exhibited a low amount of residual lithium to 2890 ppm. In the lithium metal oxide particles of Comparative Example 3, on which the humidification treatment was performed at room temperature, the amount of residual lithium was rather increased to 6420 ppm. It is considered that the residual lithium is increased due to the reaction between a trace amount of CO₂ contained in the air and moisture adsorbed to the lithium metal oxide particles.

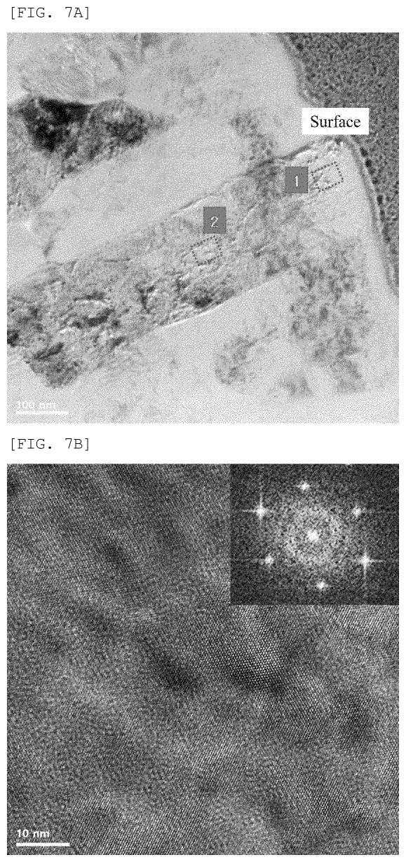

Referring to FIGS. 6(A) and (B), in the case of the lithium metal oxide particle of Comparative Example 1, it can be confirmed that a separate water washing treatment is not performed, such that only the layered structure is observed.

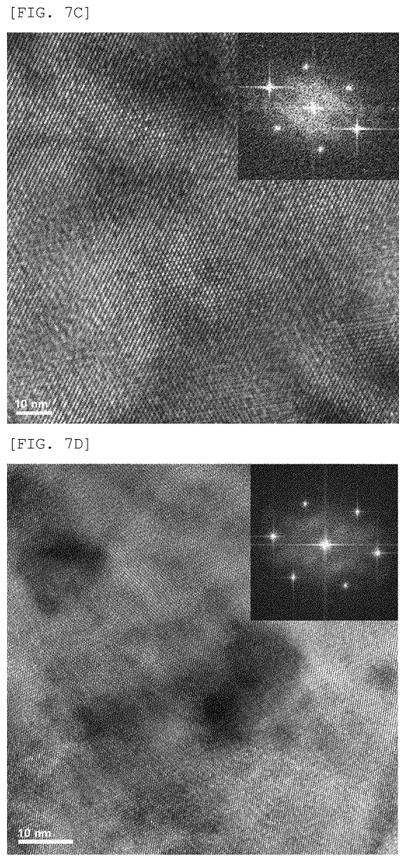

Referring to FIGS. 7(A) to 7(C), in the case of the lithium metal oxide particle of Comparative Example 2, it can be confirmed that cubic structures are formed not only in a region having a thickness of 200 nm from the surface thereof, but also in other regions (e.g., a region of 200 nm depth from the surface thereof, and a region with a depth greater than 200 nm from the surface thereof).

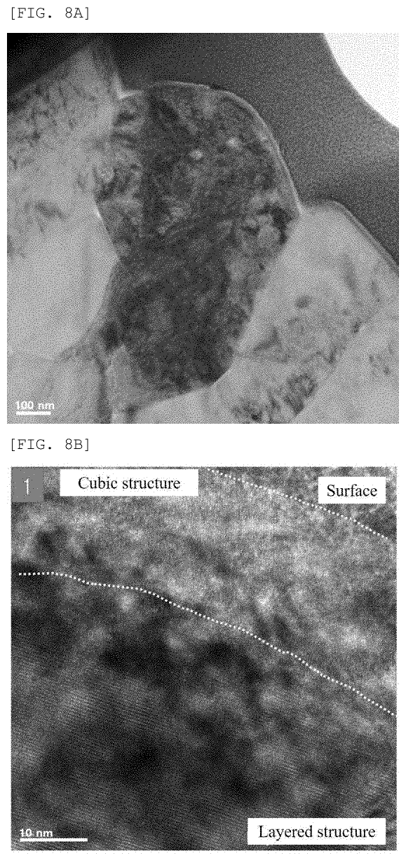

In particular, Referring to FIG. 7(D), in the case of the lithium metal oxide particle of Comparative Example 2, cubic structuring was also observed in lower primary particles (i.e., the primary particles inside the lithium metal oxide particle) in contact with the outermost primary particles among the primary particles constituting the lithium metal oxide particle (secondary particle). On the other hand, referring to FIG. 8(B), in the case of the lithium metal oxide particle of Example 1, it can be confirmed that the cubic structure is formed only in a region having a thickness of 25 nm from the surface (see the region between yellow lines in FIG. 8(B)).

Meanwhile, in the case of the lithium metal oxide particle of Comparative Example 3, since the amount of residual lithium was rather increased, it was not confirmed whether the crystal structure was changed.

Referring to Table 2 above, it can be confirmed that the secondary batteries of the examples exhibit improved values compared to the secondary batteries of the comparative examples in terms of efficiency and capacity retention rate.

In the case of the secondary batteries of Comparative Examples 6 and 8, it was confirmed that the capacity retention rate was decreased due to the loss of Li on the surface of the lithium metal oxide particles by washing with water. In the case of the secondary battery of Comparative Example 7, coating with boron was carried out in a state in which the amount of residual lithium present in lithium metal oxide particle was high by performing humidification treatment. Accordingly, the residual lithium interfered the transfer of Li, and thereby exhibiting inferior values in the initial charge capacity, the initial discharge capacity and efficiency.

Meanwhile, Preparative Example 1 may finally provide lithium metal oxide particles having a low BET by using the composite hydroxide having a low BET. Accordingly, the lithium metal oxide particles according to Preparative Example 1 may have a smaller amount of surface residual lithium. Meanwhile, the lithium metal oxide particles according to Preparative Example 2 have a relatively high BET, and thus, they may have a larger amount of residual lithium than that of the lithium metal oxide particles according to Preparative Example 1.

More specifically, in the lithium metal oxide particles according to Preparative Example 2 and Comparative Example 4, the amount of residual lithium was measured to be as high as 9420 ppm. In addition, in the case of the lithium metal oxide particles of the examples and the comparative examples based on the lithium metal oxide particles according to Preparative Example 2, compared to the examples and the comparative examples based on the lithium metal oxide particles according to Preparative Example 1, the amount of residual lithium was measured to be high.

Referring to Examples 4 and 5, when inputting an oxidant such as hydrogen peroxide (H₂O₂) or sodium peroxide disulfate (Na₂S₂O₈) during steam treatment, it can be confirmed that the effect of reducing residual lithium is further improved. In more detail, as shown in the following reaction formula, the oxidant is thermally decomposed to generate hydroxyl radicals (HO^{•}) or oxygen (O₂) capable of removing the residual lithium. Accordingly, when additionally treating with the oxidant, the effect of reducing residual lithium may be more improved than the case of treating only with the steam.

2H₂O₂+heat→2H₂O+O₂ or 2HO^{•}, a small amount is decomposed into HO^{•}

Na₂S₂O₈→2Na²⁺+S₂O₈²⁻

S₂O₈²⁻+heat→SO₄^{•-}+SO₄²⁻

SO₄^{•-}+H₂O→HO^{•}+SO₄²⁻+H⁺

The lithium metal oxide particles of Comparative Example 5, which were subjected to water washing treatment, exhibited a low amount of residual lithium. However, in the lithium metal oxide particle of Comparative Example 5, cubic structures were observed not only in the region having a thickness of 200 nm from the surface thereof, but also in other regions (e.g., a region of 200 nm depth from the surface thereof, and a region with a depth greater than 200 nm from the surface thereof). In addition, in the case of the lithium metal oxide particles of Comparative Example 5, cubic structuring was observed in the lower primary particles in contact with the outermost primary particles among the primary particles constituting the lithium metal oxide particle.

The secondary battery of Comparative Example 8 exhibited a low capacity retention rate due to the loss of Li on the surface of the lithium metal oxide particles by washing with water. In addition, the secondary battery of Comparative Example 8 exhibited a low amount of residual lithium, which is known as a factor affecting the gas generation amount, but rather exhibited a high value in evaluation of the gas generation amount. This is considered to be due to cubic structuring of the layered structure of the lithium metal oxide particles due to the water washing treatment.

Meanwhile, the secondary batteries of the examples exhibited a relatively high capacity retention rate and a low gas generation amount by minimizing the loss of Li on the surface of the lithium metal oxide particles and cubic structuring of the layered structure due to the water washing treatment.

In Example 8, after treating the lithium metal oxide particles with steam, coating with boron was performed in the same reaction furnace without taking out the lithium metal oxide particles from the reaction furnace. In addition, in Example 9, after taking out the lithium metal oxide particles from the reaction furnace, coating with boron was performed using separate RHK equipment. As can be seen in Examples 8 and 9, the capacity retention rate and the gas generation amount were measured at similar levels to each other. From this, it can be confirmed that, when using the ribbon type mixer reaction furnace, coating on the lithium metal oxide particles may be performed in simpler manner.

In the case of Example 11, in which coating with boron was performed after the steam treatment by inputting an oxidant, a more improved capacity retention rate and reduced gas generation were exhibited than Example 8 in which the coating with boron was performed after the steam treatment without inputting an oxidant.

The secondary batteries of Examples 11 and 12 exhibited more improved capacity retention and reduced gas generation than those of other embodiments. This is considered to be due to the fact that sulfur (S) or aluminum (Al) contained in the steam is reacted with Li on the surface of the cathode active material particles to additionally form a passivation layer such as amorphous Li₂SO₄ and LiAlO₂.

What is claimed is:

1. A cathode active material comprising:
lithium metal oxide particle which includes a layered crystal structure and a cubic crystal structure,
wherein the lithium metal oxide particle contains 80 mol % or more of nickel based on a total number of moles of all elements except for lithium and oxygen, and
the lithium metal oxide particle includes the cubic crystal structure only in a region having a thickness of less than 200 nm from a surface thereof when analyzing a crystal structure thereof by a high-resolution transmission electron microscopy (HR-TEM).

2. The cathode active material according to claim 1, the lithium metal oxide particle includes the cubic crystal structure only in a region having a thickness of 25 nm from a surface thereof.

3. The cathode active material according to claim 1, wherein the lithium metal oxide particle has a specific surface area of 0.25 m²/g or less.

4. The cathode active material according to claim 1, wherein the lithium metal oxide particle has a specific surface area of 0.05 m²/g to 0.25 m²/g.

5. The cathode active material according to claim 1, wherein a total amount of residual lithium present in the lithium metal oxide particle is 6000 ppm or less.

6. The cathode active material according to claim 1, wherein a total amount of residual lithium present in the lithium metal oxide particle is 3000 ppm or less.

7. The cathode active material according to claim 1, wherein the cathode active material further comprises a coating layer formed on at least a portion of the surface of the lithium metal oxide particle and including metal, metalloid or non-metal.

8. The cathode active material according to claim 7, wherein the coating layer includes at least one of aluminum, zirconium, sulfur and boron.

9. The cathode active material according to claim 1, the lithium metal oxide particle is represented by Formula 1.
LixNiaCobMcOy [Formula 1]
In Formula 1, M is at least one of Al, Zr, Ti, B, Mg, Mn, Ba, Si, Y, W and Sr, and x, y, a, b and c are a range of 0.9≤x≤1.2, 1.9≤y≤2.1, 0.8≤a≤1, 0≤c/(a+b)≤0.13 and 0≤c≤0.11.

10. A method of manufacturing a cathode active material, comprising:
preparing lithium metal oxide particles; and
treating the lithium metal oxide particles with steam or a steam-containing gas without washing with water.

11. The method of manufacturing a cathode active material according to claim 10, wherein each of the lithium metal oxide particles includes a layered crystal structure, and contains 80 mol % or more of nickel based on a total number of moles of all elements except for lithium and oxygen.

12. The method of manufacturing a cathode active material according to claim 10, wherein the steam-containing gas includes at least one of oxygen gas, nitrogen gas and argon gas.

13. The method of manufacturing a cathode active material according to claim 10, wherein the treating with steam or a steam-containing gas is performed at 100° C. or higher, and the steam or the steam-containing gas contains hydroxyl radical.

14. The method of manufacturing a cathode active material according to claim 10, wherein the treating with steam or a steam-containing gas comprises: increasing a material temperature of the lithium metal oxide particle; and spraying water on the lithium metal oxide particle with the increased material temperature.

15. The method of manufacturing a cathode active material according to claim 14, wherein the lithium metal oxide particle with the increased material temperature has a material temperature of 100 to 500° C.

16. The method of manufacturing a cathode active material according to claim 10, wherein the treating with steam or a steam-containing gas comprises: loading the lithium metal oxide particles into a reaction furnace having an internal temperature of 100° C. or higher; and spraying water on the lithium metal oxide particles.

17. The method of manufacturing a cathode active material according to claim 10, wherein the treating with steam or a steam-containing gas is performed while stirring the lithium metal oxide particles.

18. The method of manufacturing a cathode active material according to claim 10, wherein the step of treating with steam or a steam-containing gas comprises supplying an oxidant.

19. The method of manufacturing a cathode active material according to claim 18, wherein the oxidant includes at least one of hydrogen peroxide (H₂O₂), potassium permanganate (KMnO₄), and sodium peroxide disulfate (Na₂S₂O₈).

20. The method of manufacturing a cathode active material according to claim 10, wherein the treating with steam or a steam-containing gas comprises supplying a coating source including metal, metalloid or non-metal.

21. The method of manufacturing a cathode active material according to claim 20, wherein the coating source includes at least one of sodium aluminate (NaAlO₂), zirconium nitrate (Zr(NO₃)₄), sodium peroxide disulfate (Na₂S₂O₈) and boric acid (H₃BO₃).

22. The method of manufacturing a cathode active material according to claim 10, further comprising coating at least a portion of the surface of the lithium metal oxide particles with metal, metalloid or non-metal after the treating with steam or a steam-containing gas.

23. A lithium secondary battery comprising:
the cathode which comprises the cathode active material according to claim 1; and
an anode disposed to face the cathode.
